(19) United States
(12) Patent Application Publication
(10) Pub. No.: US 2023/0240350 A1
(43) Pub. Date: Aug. 3, 2023

(54) Methods for Creating of Hemp-Based Extrudates

(71) Applicant: The Livekindly Company Switzerland GmbH, Pfäffikon (CH)

(72) Inventors: Marco Schlüter, Quakenbrück (DE); Achim Knoch, Minden (DE)

(21) Appl. No.: 18/112,995

(22) Filed: Feb. 22, 2023

Related U.S. Application Data
(63) Continuation-in-part of application No. 17/829,165, filed on May 31, 2022.
(60) Provisional application No. 63/305,170, filed on Jan. 31, 2022.

(51) Int. Cl. A23P 30/20; A23J 3/14; A23J 3/22; A23J 3/26

(52) U.S. Cl. CPC A23P 30/20; A23J 3/14; A23J 3/227; A23J 3/26

(57) ABSTRACT

Provided herein are exemplary methods for creating hemp-based HMEs by adding a hemp-based admixture to an extruder, adding a liquid to the hemp-based admixture in the extruder, heating the hemp-based admixture within the extruder to a predetermined temperature, and extruding the hemp-based admixture through a die of the extruder to create a hemp-based high-moisture extrudate (HME), the hemp-based HME a protein structure that has a liquid retaining ability of approximately 80 percent, by weight.

### CROSS REFERENCE TO RELATED APPLICATIONS

This application is a continuation-in-part of U.S. application Ser. No. 17/829,165, filed on May 31, 2022, which claims the benefit and priority of U.S. Provisional Application Ser. No. 63/305,170, filed on Jan. 31, 2022, each of which are hereby incorporated by reference herein in its entirety, as if fully set forth herein, for all purposes.

### FIELD OF THE TECHNOLOGY

The present technology relates generally to hemp-based extrudates and other similar plan-based products that approximate the mouthfeel and juiciness of a meat-based product.

### SUMMARY

According to some embodiments, the present disclosure is directed to a method comprising: adding a hemp-based admixture to an extruder; adding a liquid to the hemp-based admixture in the extruder; heating the hemp-based admixture within the extruder to a predetermined temperature; and extruding the hemp-based admixture through a die of the extruder to create a hemp-based high-moisture extrudate (HME), the hemp-based HME having a protein structure that can retain an amount of liquid of approximately 80 percent, by weight, of the hemp-based HME. In general, the extrusion itself is carried out with water contents of 50 to 65%. In a process downstream of the extrusion process (cooking), up to 80% of the initial weight of the extrudate is added to the extrudate.

According to some embodiments, the present disclosure is directed to a method comprising: adding a hemp-based admixture to an extruder; adding a liquid to the hemp-based admixture in the extruder; heating the hemp-based admixture within the extruder to a predetermined temperature; extruding the hemp-based admixture through a die of the extruder to create a hemp-based high-moisture extrudate (HME), the hemp-based HME having a protein structure that can retain an amount of liquid of approximately 80 percent, by weight, of the hemp-based HME; separating the hemp-based HME into pieces; and cooking the hemp-based HME pieces in a cooking liquid until the hemp-based HME pieces retain the cooking liquid at an amount that is approximately 80% of a dry weight of the hemp-based HME pieces.

According to various exemplary embodiments, the admixture may include a combination of hemp and soy, a combination of hemp and gluten, or a combination of hemp, soy and gluten. The additive may include sodium hydroxide in a range of approximately 0.05% to approximately 1.00%, and nitrogen in a range of approximately 0.01% to approximately 5.00%. The extrudate may be boiled in water to achieve a high water absorption of between approximately 20% and 120%, or boiling the extrudate in water and spice to achieve high water and spice absorption of between approximately 20% and 120%. A marinade may be added before or during the cooking, with a content of the marinade ranging from approximately 1% to approximately 20%.

The combinations of proteins, in some exemplary embodiments, is 25% hemp and 75% soy, 35% hemp and 65% soy, 45% hemp and 55% soy or 55% hemp and 45% soy.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1A is an exemplary flowchart for creating a high moisture extrudate (“HME”) with high water uptake.

FIG. 1B shows 64 exemplary structure-forming protein combinations.

FIG. 2A shows structural characteristics of a standard HME after extrusion.

FIG. 2B shows structural characteristics of a base juicy HME after extrusion.

FIGS. 3A-3B show examples of HME material.

FIGS. 4A-4B show upon the opening of the base juicy HME structure, how the addition of sodium hydroxide influences pH value.

FIG. 5A shows a chart comparing water absorption of various extrudate compositions.

FIG. 5B shows an exemplary extrudate with high water uptake.

FIGS. 6A-6B show exemplary extrudates of 50% soy-50% hemp composition with high water uptake.

FIGS. 7A-7B show both uncooked and cooked HME material.

FIG. 8 is a flowchart of an example method for creating a hemp-based HME and cooking the same.

### DETAILED DESCRIPTION

Meat analogues and meat alternative products made out of plant proteins (including also protein enriched flours, concentrates and isolates) and plant products are gaining in popularity, this is due to a variety of factors including increased environmental consciousness. However, in their current state, meat analogues, meat alternatives and plant-based foods and proteins may suffer from several disadvantages and shortcomings relative to natural meat. Some obvious disadvantages and shortcomings of current alternative meat products are their taste and texture, which are different from and fail to replicate the taste and texture of natural meats, these alternatives also fail to resemble meats in color and other physical aspects.

Therefore, in the field of meat analogue or meat alternative manufacturing processes, it is generally accepted that there are several goals that the final meat analogue product and the manufacturing process itself must meet; these include alternative meat products that are desirable to the senses, tasty and affordable. More specifically, the alternative meat products should have a texture very similar to that of natural meats. A meat-like texture allows the bite or crunch of a meat analogue product to feel like that of natural meats to the consumer. Other goals are for the meat analogue to taste like and have the same color and/or physically resemble natural meats.

To realize these goals, the meat analogue industry has moved towards a High Moisture Extrudate (HME) extrusion process. In general, HME is a mechanical extrusion process for texturizing vegetable protein(s) into a product with fibrous texture like animal meat. HME extrusion converts proteins and polysaccharides of proteins into fibrous structure or matrix that is used in the production of meat replacements or substitutes. The protein mixtures disclosed herein are homogeneous mixtures that form fibrous layers when extruded. Separation of these layers through mechanical mixing, heating, and/or extruding produces a protein matrix that can receive and retain cooking liquid during a cooking process. In some instances, the protein matrix can retain cooking liquid of approximately 80% by weight, but other higher percentages can also be achieved.

An HME extrusion process may include shearing. It is generally accepted that the HME extrusion process involves several standardized steps, these steps may be modifiable, altered, added to, or removed depending on the mixtures, recipes and ingredients used as well as the desired product outcome. However, the standard process includes feeding and conveying ingredients into an extruder, mixing, heating and melting the extrudate mixture and compressing the mixture and then to achieve and/or maintain the desired meat-like texture, to press the extrudate mixture into a cooling die which further cools and structures the mixture. In this process, protein and water can be mixed in a ratio of 1:1, 1:2 (one part protein and two parts water), 1:3 (one part protein and three parts water), 2:1 (two parts protein and one part water), 2:2 (two parts protein and two parts water) or in any other ratio, both materials are added to the extruder together or separately. The challenge, however, is to produce an HME material with high water absorption.

Post-processing steps may also be added after the HME extrusion process after the cooling die which may include cutting and shearing the protein, or more typically after the extrudate mixture leaves the cooling die, and these steps may include cutting, shearing, cooking, freezing, storing, or adding flavors, fats and other food manufacturing and culinary additives.

A texturized product, or in other embodiments an extrudate mixture that is fed into and/or is created in an extruder may be comprised of any food manufacturing ingredient including and not limited to plant proteins, soy or pea proteins or isolates, plant protein concentrates, protein isolates, meat proteins and compositions, and protein products and concentrates, as well as additives such as flavor enhancers, preservatives, PH agents, color additives, fats, bonding agents and compositions, salts as well water, other solutions and liquids. The extrudate mixture may be pre-mixed before feeding into the extruder or separate components may be added individually into the extruder, or a combination of both.

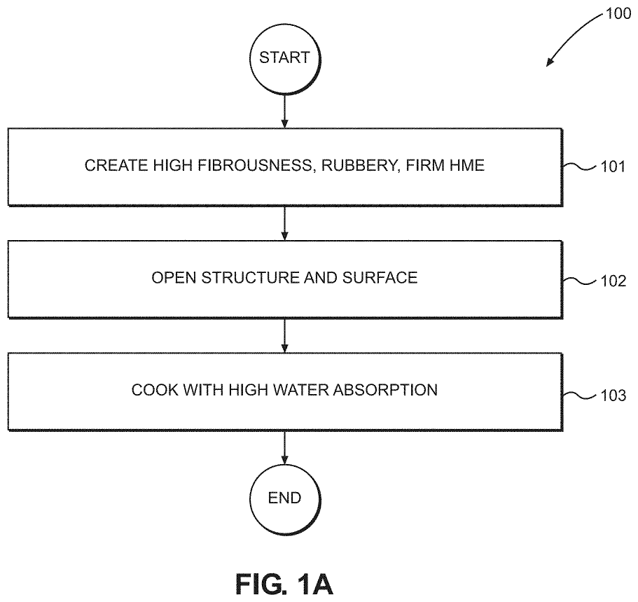

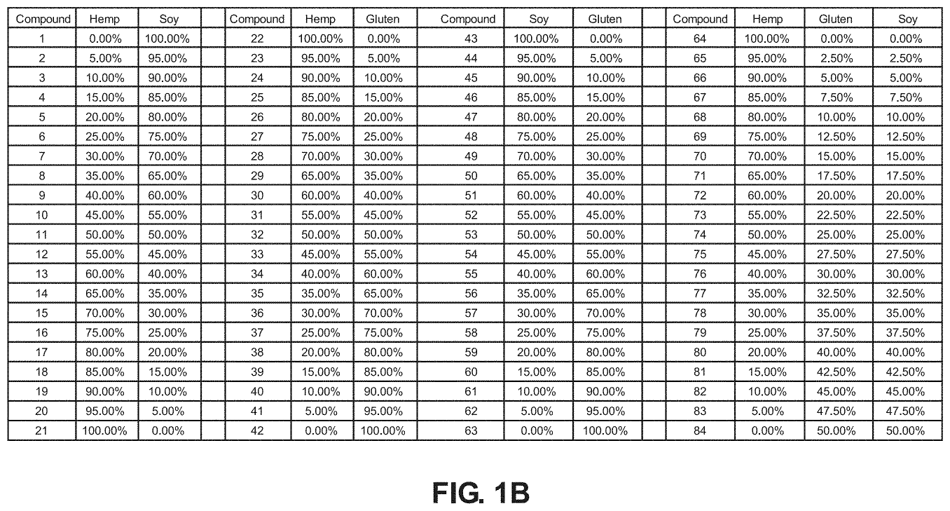

FIG. 1A is an exemplary flowchart for how to generate a HME material with high water uptake. According to various exemplary embodiments, a structure is produced that closely matches the structure of meat, preferably as a whole muscle. To achieve this goal, optimization of HME structure is aimed at different levels (process, recipe, pre-and post-processing technology).

At step 101, a high fibrousness, rubbery, firm high moisture extrudate is created. With respect to materials to form the HME, highly structured protein is used, in some cases hemp in a range of approximately 0% to 100%, soy in a range of 0% to approximately 100% and gluten in a range of approximately 0% to 100%. Additionally, strong structure-forming protein combinations may be utilized, including: Hemp-Soy; Hemp-Gluten; Soy-Gluten; Hemp-Soy-Gluten; and other alternative proteins, including peas.

FIG. 1B shows 64 exemplary structure-forming protein combinations. With respect to parameter settings of the extruder, in exemplary embodiments, higher temperatures and increased shearing are employed. With respect to additives, the goal is to increase the pH (e.g., 6 or 6.8 to 7.5) for increased water uptake into the HME. It is interesting to note that the HME is sensitive to changes in pH.

The extrusion process may involve combinations of: High energy input (e.g., specific mechanical energy input); High product temperature by high barrel temperature at approximately 100 degrees Celsius to 200 degrees Celsius; High screw speed at approximately 500 to 1200 revolutions per minute; Adding gas, e.g., Nitrogen in volumes (of the extruder) of approximately 0%, 1% to 5%; and Adding additives, e.g., Sodium Hydroxide in volumes (of the extruder) of approximately 0%, 0.05% to 1%. Other additives may be used to influence the pH value.

At step 102, the structure and surface of the high moisture extrudate is opened. This step happens after the extrusion and after the cooling die. The structure and surface are opened and a needle roller is used to increase the uptake of water. The opening of the structure may be performed with a mechanical stress, such as with a needle roller, a roller mill or similar processes. In some exemplary embodiments, the HME material, after undergoing the HME process and passing through a control system, is precut, then fine cut into any shape via a continuous cutter or other such equipment. The extrudate may also be used as a material for the production of formed products. For this purpose, the material may be comminuted before it is used in a dough.

Additionally, gas (e.g., pure Nitrogen) is added in the extruder to make the HME more sponge-like (in some cases having a thickness of 10-12 millimeters) with the ability to increase the uptake of water. The aim here is not to create a sponge structure but to enable the structure to absorb more water. It will be sponge like as air bubbles are included, but these bubbles are super fine and cannot be seen by the naked eye directly. At the same time, the fiber is divided and less homogenous.

With respect to adding gas, steam and water between the extruder and die, in some embodiments the present technology is directed to a system for dosing and mixing ingredients in a High Moisture Extrusion process, the system comprising: an extruder to mix ingredients to turn them into a protein extrudate; a cooling die to cool the protein extrudate and to cool an enhanced extrudate with ingredients added after the extruder; an interim plate connecting the extruder and the cooling die, to add and mix further ingredients, and facilitate movement of the protein extrudate and the enhanced extrudate into the cooling die, the interim plate further comprising: one or more interim plate inlets to allow the entry of the protein extrudate from the extruder into the interim plate; one or more dosing inlets for adding new ingredients to the protein extrudate that exits the extruder and enters the interim plate, the dosing inlets being placed on any location on the interim plate; an at least one static mixer, which mixes the new ingredients with the protein extrudate to form the enhanced extrudate; one or more flow channels to facilitate the movement of the extrudate and the enhanced extrudate through the interim plate (which may also include inserts and a special feeding system to the interim plate) and into one or more channels of the cooling die; and one or more interim plate outlets to allow the flow of the protein extrudate and the enhanced extrudate into the cooling die.

In various embodiments, the system incorporates a low degree of mixing by the static mixer, when mixing new ingredients with the protein extrudate to form the enhanced extrudate. This ensures that the enhanced extrudate is not homogenized.

At step 103, the high moisture extrudate is cooked with high water absorption. In various exemplary embodiments, this process is performed with or without vacuum cooking and may last approximately 15 to 90 minutes. In various exemplary cases, water absorption increases from approximately 40% to approximately 80%.

The cooking process can involve: Boiling the HME in water to achieve high water absorption of approximately 20% to 120%; Boiling the HME in water and additives such as spice (or a flavor(s)) mix to achieve high water and spice absorption of approximately 20% to 120%; and adding marinade before or during the cooking process to achieve an approximate marinade content of 1% to 20%.

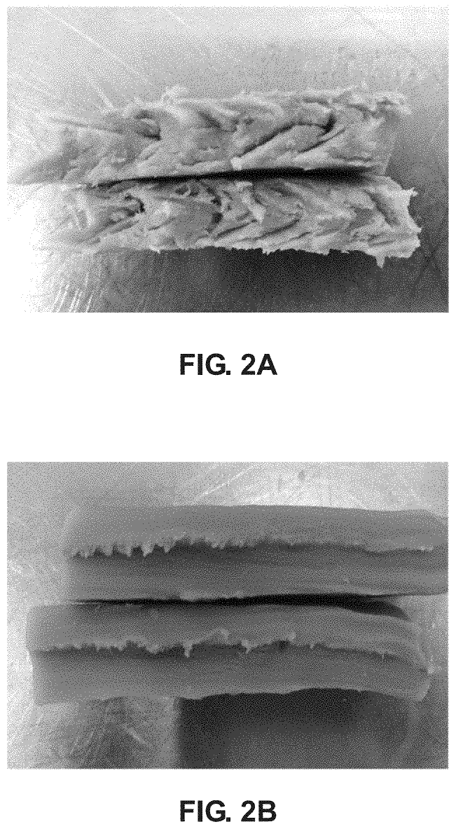

FIG. 2A shows structural characteristics of a standard HME after extrusion. As shown by the exemplary standard HME after extrusion, the properties include: Medium fibrous structure; Low juiciness; Medium compactness; Medium homogeneity; and Medium strength.

FIG. 2B shows structural characteristics of a base juicy HME after extrusion. As shown by the base juicy HME after extrusion, the properties include: High fibrous structure; No juiciness; High compactness; High homogeneity; High strength; and High elasticity.

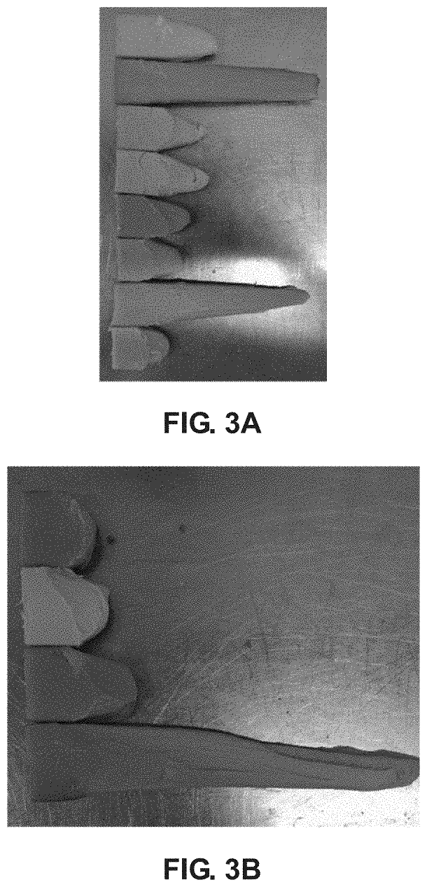

FIGS. 3A-3C show the creating of high fibrous HME. Shown in FIGS. 3A-3C are different flow profiles. The length of the flow profile is an indicator of the degree of structure formation. FIG. 3A shows the choosing of the high structure plant protein. FIG. 3B shows the influence of the pH value.

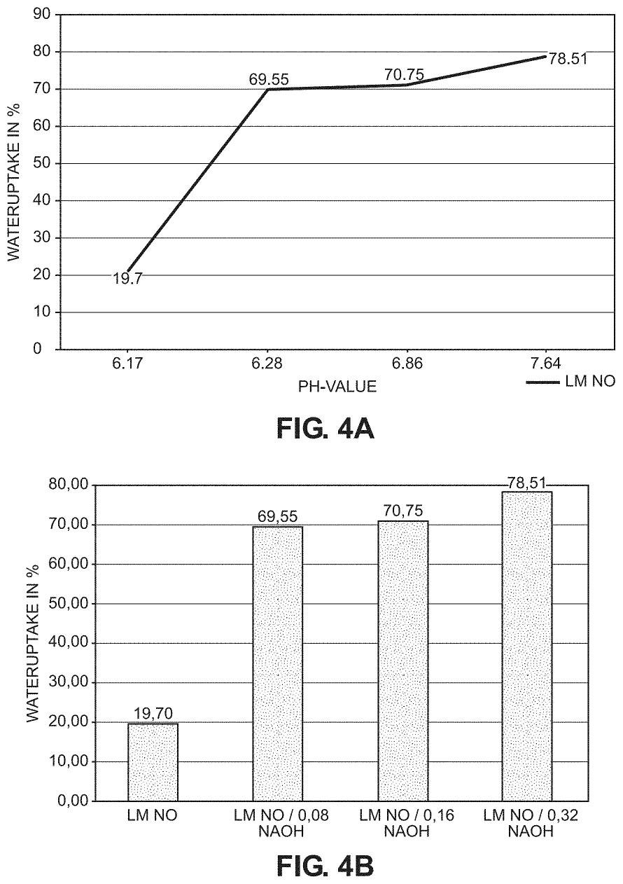

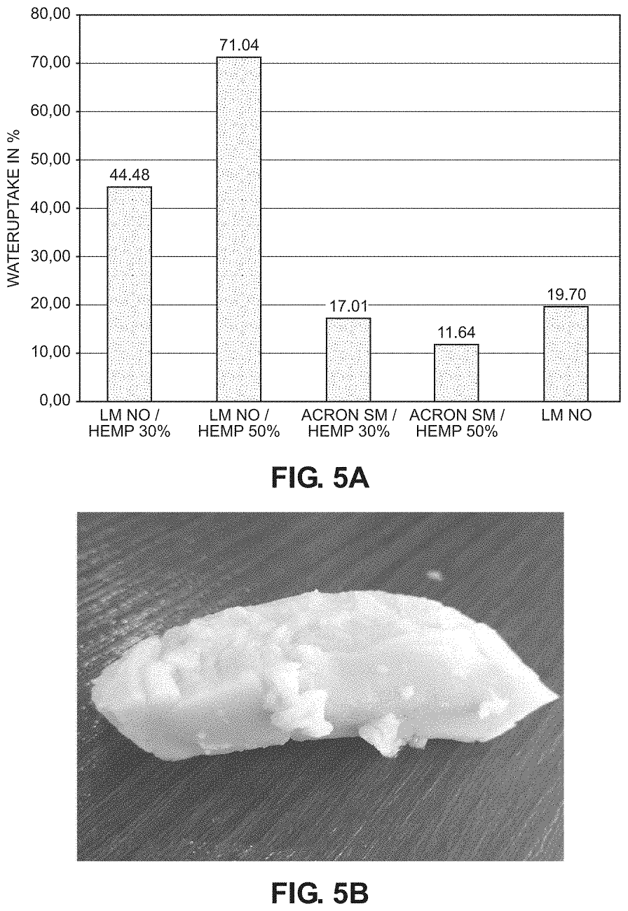

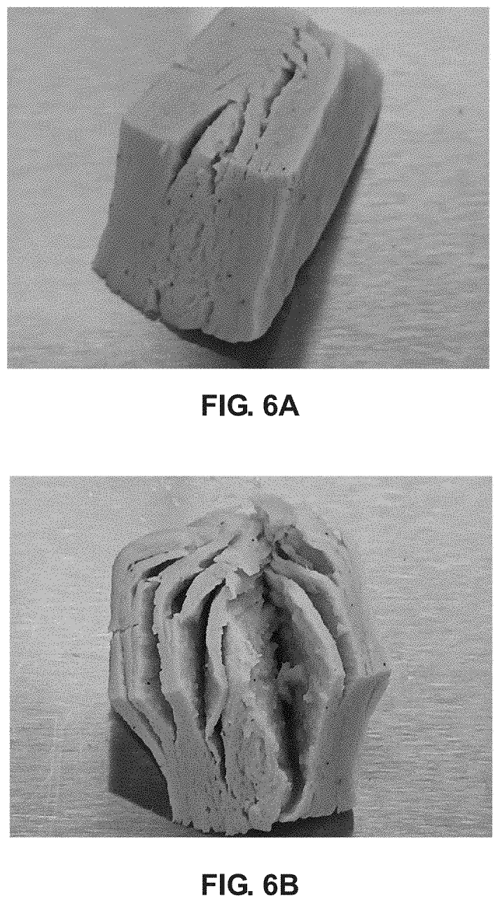

FIGS. 4A-4B show upon the opening of the base juicy HME structure, how the addition of Sodium Hydroxide influences pH value. FIG. 5A shows a chart comparing water absorption of various extrudate compositions. FIG. 5B shows an exemplary extrudate with high water uptake. FIGS. 6A-6B show exemplary extrudates of 50% soy-50% hemp composition with high water uptake.

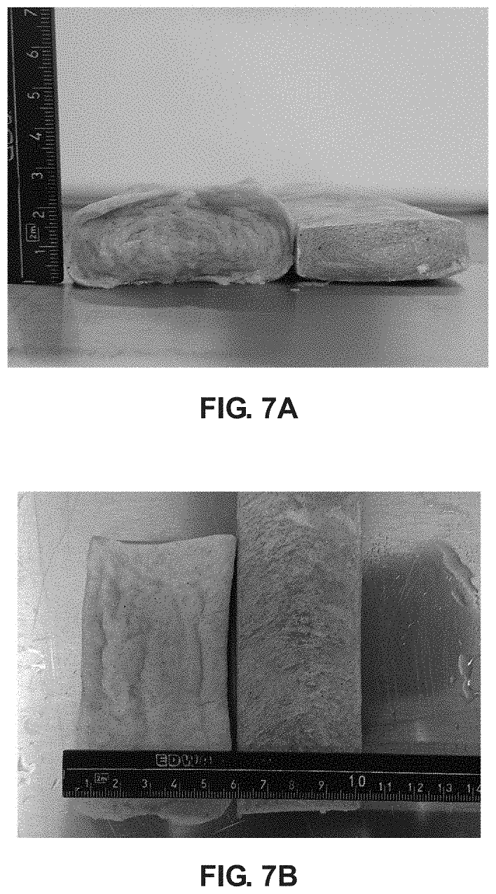

FIGS. 7A-7B show both uncooked and cooked HME material, with a view from the side and from the top. The increase in volume of the samples is caused by the combination of the special extrusion process and the high water uptake.

According to some embodiments, methods are disclosed herein for producing a meatless product that mimics the mouth-feel (e.g., chew and juiciness) of a meat-based product. An example hemp-based HME and its mouth-feel result from how the hemp-based HME is produced, as well as how it is cooked into a consumable product.

The production of the hemp-based HME can initially begin with the creation of a dry mix of plant protein powders that can be processed so as to create a structure that has optimized water uptake properties when cooked. In some embodiments, the dry mix can be pre-processed by heat-treating the powders individually or as an admixture.

For example, the dry powder can be baked at a particular temperature for a predetermined period of time. This pre-processing may aid in the denaturing of the hemp proteins. It will be understood that hemp protein is made up of the two digestible globular types of proteins, edestin (60-80%) and 2S albumin, with edestin also being rich in the essential amino acids. Also, the structure of hemp protein may be affected by pH levels. Each type of hemp protein may have an isoelectric point that is unique. Thus, to adjust the pH level of a hemp protein, it may be advantageous to determine the isoelectric point. The isoelectric point of the hemp protein also affects the structure of the hemp protein, and the structure of the hemp protein is determinative of how much moisture (e.g., water uptake) the hemp protein can absorb.

In some embodiments, a water absorption potential of 80% (by weight) the hemp-based HME is advantageous. For example, one hundred grams of hemp-based HME can retain 80 grams or more of cooking liquid. The cooking liquid is retained interstitially. That is, the cooking liquid is retained in the layers of the protein matrix and is released upon chewing by a user. The state of the hemp-based HME after being extruded is referred to as a “dry state”. The “dry” hemp-based HME can be hydrated with a cooking liquid. The amount of cooking liquid that the dry hemp-based HME can retain is, again, at least 80% of the dry weight of the hemp-based HME. Using the example above, if the “dry” weight of the hemp-based HME is 100 grams, the amount of cooking liquid that can be retained is at least 80 grams, resulting in a hydrated hemp-based HME that has an overall weight of 180 grams.

Other water absorption potentials can also be used, but it will be understood that an increase in the water absorption potential for a hemp-based HME can be varied (increased) by increasing the pH of the hemp protein used to produce the hemp-based HME. As noted above, with respect to additives, the goal is to increase the pH (e.g., 6 or 6.8 to 7.5) for increased water absorption into the hemp-based HME. To be sure, the water absorption of interest relates to the liquid absorbed by the hemp-based HME during cooking, and not during the extrusion process.

In some embodiments, the mixture of protein powders used to produce a hemp-based HME can include an amount of a hemp-based protein powder in combination with another protein. In various embodiments, the hemp-based protein powder can be combined with other protein powders to produce an admixture. One example admixture includes a percentage of hemp powder and a percentage of soy powder. To be sure, unless otherwise noted, the term “powder” as used herein may generally refer to a protein powder. While soy powder has been provided as an example protein powder, other plant-based protein powders can also be used such as pea, quinoa, chia, tofu, peanut, nutritional yeasts, cruciferous, rice, flax, legume, or any other plant-based protein powder that would be known to one of ordinary skill in the art with the present disclosure before them.

Also, it will be understood that while the present disclosure contemplates processes for combining hemp-based protein powders with other plant-based proteins to create a meatless product, the present disclosure is not so limited and can be extended to combining hemp protein with other animal-based protein powders such as whey, casein, egg, whey isolates, and so forth.

Furthermore, some embodiments contemplate the addition of other ingredients such as lipids to mimic some aspects of meat-based products. As noted above, other compounds can be added to a hemp-based HME to increase water absorption and rendition of the hemp-based HME during a cooking process.

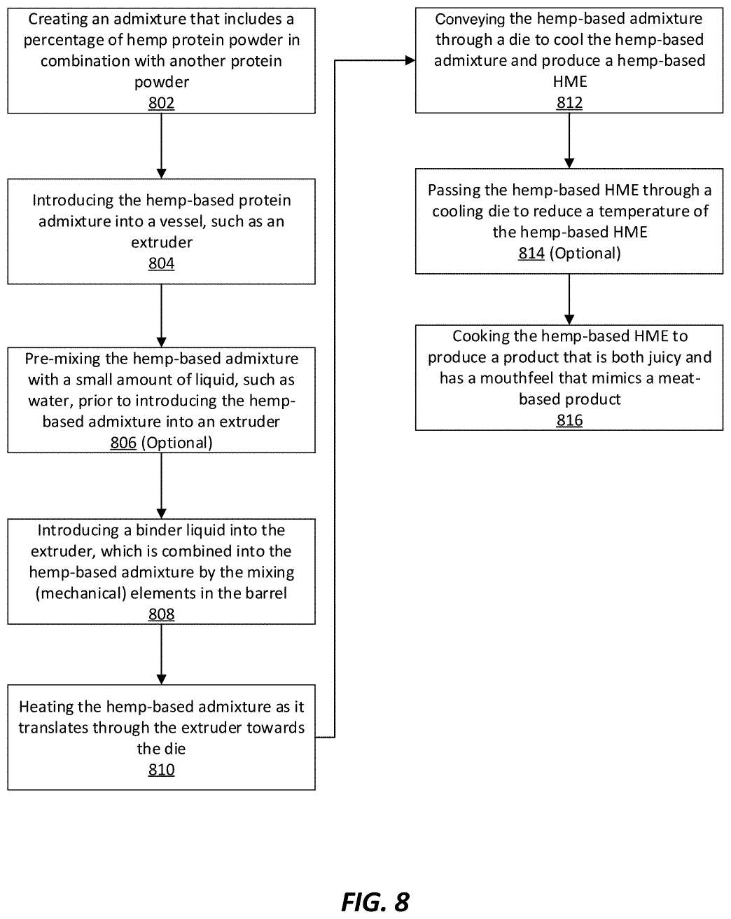

FIG. 8 is a flowchart of an example method used to create a hemp-based HME. The process can include a step 802 of creating an admixture that includes a percentage of hemp protein powder in combination with another protein powder. In this example, the admixture is 50% hemp and 50% soy. The method can include a step 804 of introducing the hemp-based protein admixture into a vessel, such as an extruder. The extruder can include a barrel having both mixing and conveyance members such as mixing paddles and a screw-type auger. The extruder can also include a die on its terminal end that is used to extrude the hemp-based admixture. The hemp-based admixture can be agitated as it is moved through the barrel towards the die.

In some embodiments, the step 802 of pre-mixing the protein powders can be omitted and the individual protein powders added to the extruder and combined together therein. Also, the method can include an optional step 806 of pre-mixing the hemp-based admixture with a small amount of liquid, such as water, prior to introducing the hemp-based admixture into an extruder. In some instances, an amount of liquid added to the hemp-based admixture can include approximately 10-15 percent, by weight, of liquid. In some instances, the temperature of the liquid added in the pre-mixing phase raises a temperature of the hemp-based admixture to a range of approximately 40 to 45 degrees Centigrade, inclusive. This pre-mixing process can be used in situations where the extruder may not heat the hemp-based admixture, such as when ambient temperatures are low. The pre-mixing process can be used to increase throughput of hemp-based admixture through the extruder.

In various embodiments, the method includes a step 808 of introducing a binder liquid into the extruder, which is combined into the hemp-based admixture by the mixing (mechanical) elements in the barrel. In some instances, the speed of the mixing process can impart forces that separate a protein structure of the hemp-based admixture. Again, the purpose of the mechanical

In some embodiments, the method can include a step 810 of heating the hemp-based admixture as it translates through the extruder towards the die. Some example temperature ranges for the hemp-based admixture while being processed include temperatures in a range of approximately 140-150 degrees Centigrade, inclusive. In some embodiments, upon leaving the extruder, the temperature of the protein mixture is 140-150° C. The temperatures in the extruder areas before the exit are higher, in the range of 120-200° C.

This can be accomplished through heating elements that are incorporated inside or external to the barrel. Thus, in general, the method heating the hemp-based admixture to a predetermined temperature inside the extruder.

The method also includes a step 812 of conveying the hemp-based admixture through a die to produce a hemp-based HME. The die that is used to extrude the hemp-based admixture can have a plurality of die apertures, each having a particular diameter (in some instances all the die apertures have the same diameter and geometry). The apertures create shearing force that affects the arrangement of the protein fibers, as noted above.

In some embodiments, the die that is used has only one aperture. In one embodiment, at the transition from the extruder to the die, i.e., at the die inlet, inserts (cooling die high velocity stream inlets) could be installed in the flow channel to influence the flow behavior of the protein melt and thus the fiber formation.

In another embodiment, at the end of the die (die exit), cutting plates are installed in front of the exit to separate the extrudate strand, which may be solid. Cutting plates of different numbers and shapes can be used. During this forced cutting, the surface of the extrudates is partially cut (sheared, stressed) in such a way that the surface becomes roughened (opens up a little) and thus enables a higher water absorption.

The method can include a step 814 of passing the hemp-based HME through a cooling die to reduce a temperature of the hemp-based HME. The thickness of the die affects how the hemp-based admixture cools as it is extruded through the die. In some embodiments, the die is configured to cool the extruded hemp-based admixture to a temperature that is in a range of approximately 70-90 degrees Centigrade, inclusive. In another embodiment, the die is configured to cool the extruded hemp-based admixture to a temperature that is in a range of approximately 80-100 degrees Centigrade, inclusive. Advantageously, some embodiments cool the extruded hemp-based admixture to a temperature that is below 100 degrees Centigrade. The cooling die can also have various apertures or could include a single aperture that shapes the hemp-based HME into a tubular product. In one embodiment, the die has an aperture with an annular shape.

The shape of the die apertures can also affect shearing of the hemp-based admixture as it is extruded. Shearing can function to separate the fiber structure of the hemp-based admixture, which enhances the liquid absorption ability of the resultant hemp-based HME. Thus, in addition to the mechanical separation of the

The combination of protein mixture, temperature control, and mechanical separation creates a hemp-based HME has a protein structure that has high functionality. That is, the hemp-based HME has an optimized fibrous structure that is optimized for water absorption in a follow-on cooking process, such as by a customer. The optimized structure has protein fibers that have been opened and have a surface area that can absorb water that is improved compared to the hemp-based admixture prior to heating and extruding.

Again, this optimized fibrous structure can be a function of any number of variables or parameters such as protein mixture, extruder temperature, screw speed, and the like. In some embodiments, the hemp-based HME has a fibrous structure that allows it to absorb approximately 80% of its weight of cooking liquid.

Step 816 can include cooking the hemp-based HME to produce a product that is both juicy and has a mouthfeel that mimics a meat-based product. This can include breaking the hemp-based HME into pieces and combining the same with a liquid such as water or a vegetable-based broth. Due to the looseness of the protein fibers of the hemp-based HME, the cooking liquid is captured between the protein fibers and are released upon mechanical chewing during eating. That is, when the user chews the cooked hemp-based HME, the liquid trapped between the fibers of the hemp-based HME are released providing a mouthfeel that is juicy and mimics how a meat-based product is experienced. As noted above, the method for creating the hemp-based HME could include processes such as introducing nitrogen during extrusion.

Also, other compounds can be mixed in such as Sodium Hydroxide for pH modification. In some instances, flavor enhancers or flavor maskers can also be added to mask or alter a flavor profile of the resulting hemp-based HME.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
adding a hemp-based admixture to an extruder;
adding a liquid to the hemp-based admixture in the extruder;
heating the hemp-based admixture within the extruder to a predetermined temperature; and
extruding the hemp-based admixture through a die of the extruder to create a hemp-based high-moisture extrudate (HME), the hemp-based HME having a protein structure that can retain an amount of liquid of approximately 80 percent, by weight, of the hemp-based HME.

2. The method according to claim 1, further comprising:
separating the hemp-based HME into pieces; and
adding an amount of a cooking liquid to the hemp-based HME so that the hemp-based HME absorbs up to 80 percent, by weight of the cooking liquid.

3. The method of claim 1, wherein extruding the hemp-based admixture opens a structure and a surface of the hemp-based admixture.

4. The method of claim 3, further comprising pre-mixing an amount of a liquid at a specified temperature into the hemp-based admixture prior to introducing the hemp-based admixture into the extruder.

5. The method of claim 1, further comprising adding a gas in the extruder.

6. The method of claim 5, the gas further comprising nitrogen in a range of approximately 0.01% to approximately 5.00%.

7. The method of claim 1, the hemp-based admixture comprising a combination of hemp and soy.

8. The method of claim 1, the hemp-based admixture comprising a combination of hemp and gluten.

9. The method of claim 1, the hemp-based admixture comprising a combination of hemp, soy and gluten.

10. The method of claim 1, further comprising including any one of an additive, a flavor enhancer, or a flavor masker.

11. The method of claim 1, wherein the additive includes sodium hydroxide in a range of approximately 0.05% to approximately 1.00%.

12. The method of claim 1, further comprising boiling the hemp-based HME in a cooking liquid to achieve high water absorption of up to 120%, by weight.

13. The method of claim 1, further comprising boiling the hemp-based HME in water and spice to achieve high water and spice absorption of up to 120%, by weight.

14. The method of claim 1, further comprising adding a marinade to the hemp-based HME before or during cooking.

15. The method of claim 14, further comprising a content of the marinade ranging from approximately 1% to approximately 20%.

16. The method of claim 1, wherein the hemp-based admixture is 25% hemp and 75% soy.

17. The method of claim 1, wherein the hemp-based admixture is 35% hemp and 65% soy.

18. The method of claim 1, wherein the hemp-based admixture is 45% hemp and 55% soy.

19. The method of claim 1, wherein the hemp-based admixture is 55% hemp and 45% soy.

20. A hemp-based high moisture extrudate product produced by a process, the process comprising:
adding a hemp-based admixture to an extruder;
adding a liquid to the hemp-based admixture in the extruder;
heating the hemp-based admixture within the extruder to a predetermined temperature; and
extruding the hemp-based admixture through a die of the extruder to create a hemp-based high-moisture extrudate (HME), the hemp-based HME a protein structure that has a liquid retaining ability of approximately 80 percent, by weight.

21. A method comprising:
adding a hemp-based admixture and a liquid to an extruder;
heating the liquid and the hemp-based admixture within the extruder to a predetermined temperature;
extruding the hemp-based admixture through a die of the extruder to create a hemp-based extrudate, the hemp-based extrudate having a protein structure that can retain an amount of liquid of approximately 80 percent, by weight, of the hemp-based extrudate;
passing the hemp-based admixture through a cooling die to cool the hemp-based extrudate;
separating the hemp-based extrudate into pieces; and
cooking the hemp-based extrudate pieces in a cooking liquid until the hemp-based extrudate pieces retain the cooking liquid at an amount that is approximately 80% of a dry weight of the hemp-based extrudate pieces.
